(19) United States
(12) Patent Application Publication
(10) Pub. No.: US 2017/0263038 A1
(43) Pub. Date: Sep. 14, 2017

(54) Real-time event data that visually changes the view based upon the data loaded on a spatial map.

(71) Applicants: John Richard Holdsworth, St. Petersburg, FL (US); Thomas O'Brien, St. Petersburg, FL (US)

(72) Inventors: John Richard Holdsworth, St. Petersburg, FL (US); Thomas O'Brien, St. Petersburg, FL (US)

(73) Assignee: Map Good News LLC, St Petersburg, FL (US)

(21) Appl. No.: 15/431,765

(22) Filed: Feb. 14, 2017

Related U.S. Application Data
(60) Provisional application No. 62/295,472, filed on Feb. 15, 2016.

(51) Int. Cl. G06T 13/80; G06T 11/20; G06F 17/30

(52) U.S. Cl. CPC G06T 13/80; G06F 17/30271; G06F 17/30241; G06T 11/206

(57) ABSTRACT

A chronological spatial map where the User Interface changes because of interactive encapsulated data that is dynamically updated due to data input, restful api's, variate nonlinear functions, geolocation radius queries, vector graphics or other forms of media on a layered chronologically contained spatial map in real-time. Custom event data can be shown and triggered to display dynamic visualizations and animations in all data formats. When the input is constrained the system triggers in real-time to display the encapsulated data uniquely the way the event manifests.

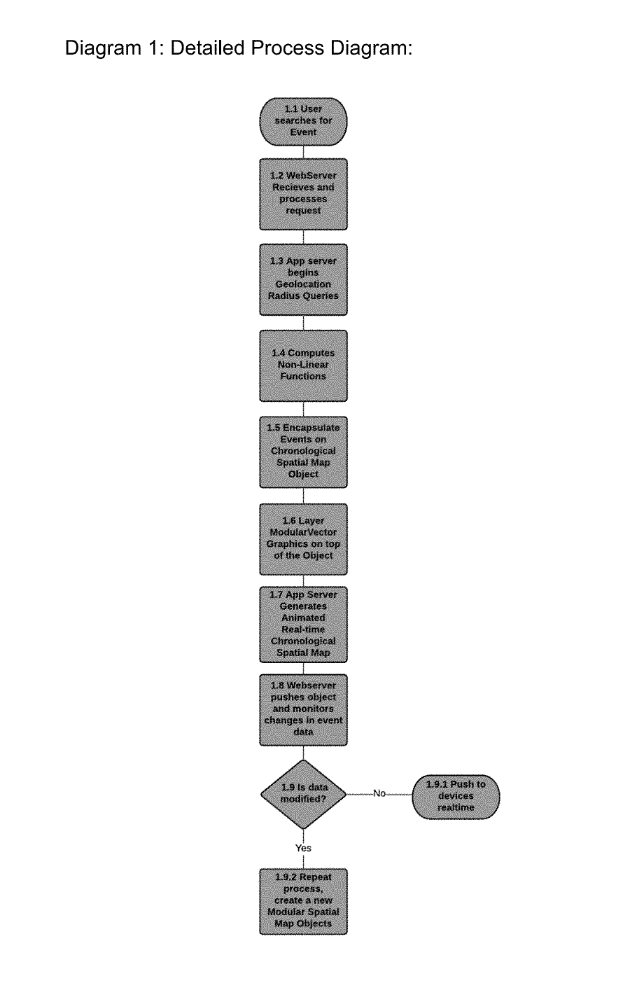

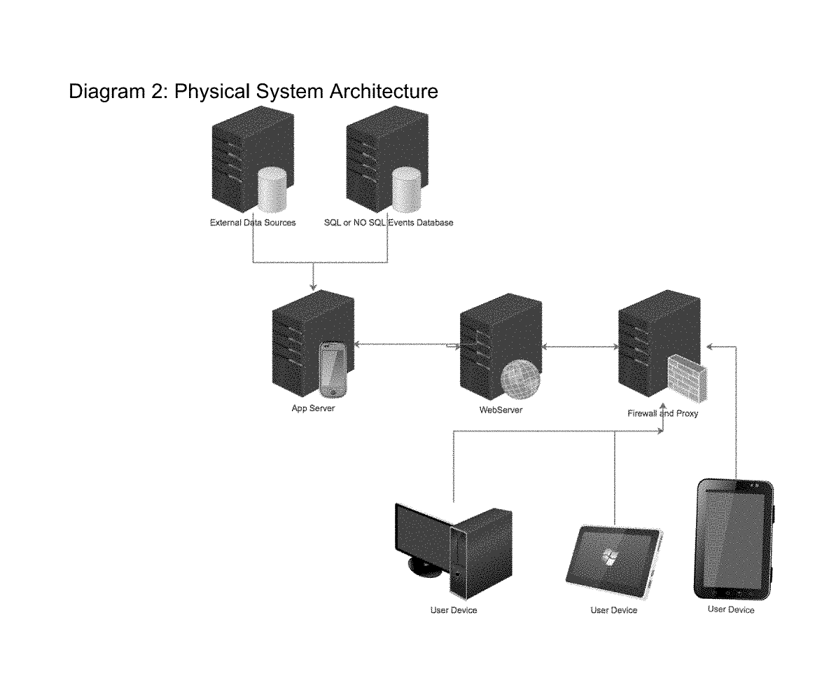

### PARENT CASE TEXT

This patent is a follow up to a provisional Application No. 62/295,472 filed Feb. 15, 2016 the title of invention: Real-time event data that visually changes the view based upon the data loaded on a spatial map.

The utility of this patent is in the real-time synchronization of the data driven variate nonlinear functions displaying as vector graphics or other forms of media on a chronological spatial map. This utility features live variable input goes to nonlinear functions that can be analyzed, displayed, and animated with vector graphics or other forms of rich media. Restful data integrations linking to the database or databases allow for the dynamic graphic and or media resource real-time updates.

### SUMMARY

The utility of this patent is an interactive animated map on a chronological geospatial container that is is directed by the data input, restful api's, variate nonlinear functions, geolocation radius queries, vector graphics and other forms of media displayed on the chronological spatial map. Real-time data input, variate nonlinear functions, vector driven graphics and geolocation radius queries synchronize to create custom interactive animated layers within a chronological container in a modular framework on the chronological spatial map. This interactive map has a variety of use events whether gamification, analysis, marketing, media, and the list goes on. In conclusion this gives the perspective of never leaving one screen to perceive a plurality of different animated events defined in real-time.

### BRIEF DESCRIPTION OF THE SPECIFICATION/DRAWINGS

1 Detailed Process Diagram:

1.1 User searches for event with a system

1.2 Web Server receives the process request

1.3 App server begins Geolocation Radius Queries

1.4 Computes Non-linear Functions which the method launches events.

1.5 Encapsulate events on a chronological spatial map object.

1.6 Layer Modular Vector Graphics on top of the chronological spatial map

1.7 App Server synchronizes Animated Real-time events on the spatial map

1.8 Web Server pushes created object and monitors changes in event

1.9 Is data modified?

1.9.1 Pushes to device in Real-time

1.9.2 Repeat process, create a new modular spatial map Object

2. High level physical system architecture:

2.1 External data sources send data to a app server

2.2 SQL or NOSQL events database feed event data to app server

2.3 App server uses nonlinear functions to compute data then encapsulates events on the chronological spatial map.

2.4 The app server depending upon the event type layers modular vector graphics on top of the spatial map object and pushes it to the web server.

2.5 Web server provides access to devices that pass the firewall and proxy.

2.6 The system that consumes the chronological map object animates depending upon the input constraints of the event.

### DETAILED DESCRIPTION

The function of patent this will be real-time moving spatial map view which includes nonlinear functions, vector graphics, geo-location radius queries and restful input data feeds where the data feeds to modular objects on the spatial map view or views to receive restful updates due to data changes nonlinear functions parameter changes. Restful updates happen due to parties, services, data feeds and/or groups creating, posting, updating and deleting events or changing objects. Variate nonlinear functions will enable the vector graphics or media object to displaying of a plurality of data types. The interactive map encapsulates data into modular layers that are dynamically updated due to restful pushes on a chronological spatial map in real-time. The main components of this are the modularity, variate nonlinear functions, vector graphics or other forms of media, the real-time display in a chronological container and a spatial map.

The modularity of this design allows for many separate working parts to come together making one seamless layered moving picture. This minimizes dependencies and allows the modular objects to be individually customizable and fed by the realtime input and the the variate nonlinear functions. The modularity also help with dependency management this constitutes declaring the dependencies of the installed components at runtime while not loading undeclared foreign objects. Modularity allows a way to coordinate the work of many interdependent mechanisms and assemble very complex systems in a reasonably reliable way. The modular design also makes it necessary for well-defined API (application program interfaces) connecting the modular parts. Variate Nonlinear functions receive the data the from parties, services, data feeds and/or groups creating, posting, updating and deleting events. The non linear program is able to have non linear constraints and objectives. The data feeds the nonlinear functions which enable the information to change variables based upon input parameters. The data feeds push dynamic updates that trigger parameters within the variables to the vector driven graphics or other forms of media.

The patent turns the data input into interactive animated graphic art for data-driven interactive animations. Every element and every attribute in these vector driven graphics can be interactive and animated. Due to the vector based graphics the data from the nonlinear functions are able to fully manipulate and animate the visual layer. The input is passed by the conditions of the nonlinear layer. The animations are code dependent and depend upon the data to update the graphics or trigger some other form of media.

Future and prior events are captured and are viewable on the Chronological spatial map at any given time. The chronological spatial map is constrained by date time.

The system uses the longitude and latitude to determine the coordinates of an event located on the chronological spatial map. Geolocation radius queries determined by the input parameters trigger the longitude and the latitude attributes and constraints of the input events.

The system recognizes modifications in the event data, and updates the spatial map reflect the changes in real time.

Use Case 1: An animated chronological spatial map can be used to play in real-time on a system where the users can create or engage with other animated objects a few good examples for gamification and interact with objects like the ducks in duck hunt, or whack-a mole, or a new real-time where is waldo.

Use Case 2: Animated chronological spatial maps can be used for marketing billboards online where users can find out business information via animated graphics provided by the clients

Use Case 3: A system in a longitude latitude position receives real time updates that are animated on a spatial map to get the latest information. This could also be viewed as an animated chronological spatial map to substitute the news outlets by providing real-time modular news animated on a map.

Definitions:

Event: is a type of trigger that is defined in an object that can pass input data between all levels of an application.

Real-Time: is a level of computer responsiveness that a user senses as sufficiently immediate or that enables the computer to keep up with some external process (for example, to present visualizations of the weather as it constantly changes). Real-time is an adjective pertaining to computers or processes that operate in real time. Real time describes a human rather than a machine sense of time.

Spatial Map View/Spatial Map Object: provides a detailed representation of real-world surfaces in the environment.

Chronological: Record of events starting with the earliest and following the order in which they occurred within a given date time.

Interactive: normally refers to products and services on digital computer-based systems which respond to the user's actions by presenting content such as text, moving image, animation, video, audio, and video games.

Modular: designed with standardized parts that can be fit together in a variety of ways.

Dynamic: (of a process or system) characterized by constant change, capable of action and/or change, of data, variables, images and inputs.

Restful: a service defines a set of resources and actions that can be accessed via URI endpoints.

Variate: random variable

Nonlinear functions: in which the output is not directly proportional to the input due to the formulas that create the output. Where the output is not moving in one direction, or not changing in one way at a regular rate of speed.

Geo-location radius queries: the process or technique of identifying the geographical location of a person or device by means of digital information processed via the Internet.

Animates: give a image or vector graphics the appearance movement Vector graphics: are the use of polygons to represent images in computer graphics. Vector graphics are based on vectors, which lead through locations called control points or nodes. Each of these points has a definite position on the x- and y-axes of the work plane and determines the direction of the path; further, each path may be assigned various attributes, including such values as stroke color, shape, curve, thickness, and fill.

Media: is digitized content that can be transmitted over the Internet or computer networks. This can include text, audio, video, and graphics.

We claim:

1. A method, comprising of a chronological spatial map that animates based upon the real-time input, and defined by set user constraints.

2. The method of claim 1, dynamically changing layered modular views objects for visualizing an event on a chronological spatial map.

3. The method according to claim 1, the displaying of event data on the chronological spatial map in a linear or nonlinear format.

4. The methods according to claim 1, the chronological spatial map synchronizes with at least one event in real time.

5. The method of claim 1, the variable data input can come from other services, parties, groups, API, databases, or data feeds.

6. The method according to claim 1, wherein a format of the event comprises a SQL format or NOSQL format and all other programming languages; in addition encompassing storing the event within a SQL database or a NOSQL database.

7. The method according to claim 1, real time updates change the modular view layers on the chronological spatial map in real time according to variate nonlinear functions.

8. The method according to claim 1, uses variate nonlinear function to encapsulate the data based on input constraints and objectives.

9. The method according to claim 1, uses vector graphics and other forms of media to display these variate nonlinear functions in a chronological spatial map.

10. The method according to claim 1, synchronizes the relationships between the real time data input, restful api's, the variate nonlinear functions, vector graphics and other media displayed modularly on a chronological spatial map.

11. A method according to claim 1, various events to be displayed on the chronological spatial map simultaneously

12. The methods according to claim 1, the events are derived based upon user input, data collection, or API's.

13. A system, which visualizes an event on a chronological spatial map.

14. The system according to claim 13, encompassing generating the event data, wherein the event data comprises at least one of these data types image data, audio data, video data, visualization data, geospatial data, or document data.

15. The system according to claim 13, including any computer, or Internet browsing compatible device that can respond and interact in real-time.

16. A method that monitors changes in event data and pushes out notifications when modified.

17. The method according to claim 16, wherein the transmitting the event data in addition comprises transmitting the data over an encrypted channel or non encrypted channel.

18. The method of claim 16, where geolocation radius queries retrieve information as object input is received.

19. The method according to claim 16, monitors changes in event data and pushes any new events to the chronological spatial map.

20. The method according to claim 16, the displaying of event data on the chronological spatial map in a linear or nonlinear format.
